(19) United States
(12) Patent Application Publication
(10) Pub. No.: US 2009/0046112 A1
(43) Pub. Date: Feb. 19, 2009

(54) Liquid Crystal Panel Driving Device, Liquid Crystal Panel driving Method, Liquid Crystal Display Device

(76) Inventors: Kazuma Hirao, Osaka (JP); Akihisa Iwamoto, Mie (JP); Hideki Morii, Mie (JP)

Correspondence Address: HARNESS, DICKEY & PIERCE, P.L.C., P.O. BOX 8910, RESTON, VA, 20195, US

(21) Appl. No.: 12/087,793

(22) PCT Filed: Nov. 6, 2006
(86) PCT No.: PCT/JP2006/322097

§ 371 Date: Jul. 15, 2008

(30) Foreign Application Priority Data
Mar. 23, 2006 (JP) 2006-081639

(51) Int. Cl. G06F 3/038

(52) U.S. Cl. 345/690

(57) ABSTRACT

In one embodiment of the present invention, a liquid crystal panel driving device for AC-driving a liquid crystal panel with first and second polarities includes an output tone generating section for generating an output tone corresponding to an input tone. With respect to the same input tone, the output tone generating section generates a first output tone when driving the liquid crystal panel with a first polarity, and generates a second output tone when driving the liquid crystal panel with a second polarity. The first and second output tones are determined based on a characteristic of the input tone and the center of amplitude of a voltage to be outputted in response to the input tone in AC driving. This allows providing a liquid crystal panel driving device capable of easily performing Ω correction with respect to each liquid crystal panel.

### TECHNICAL FIELD

The present invention relates to a liquid crystal panel driving device and a liquid crystal display device including the same.

### BACKGROUND ART

A matrix liquid crystal display device is a device in which pixels that are minimum units of an image are arrayed in a matrix manner. In particular, an active matrix liquid crystal display device having a switching element in each pixel can display a fine image, and so is used widely.

In this active matrix liquid crystal display device, in order to supply a display signal to each of the pixels, a liquid crystal panel 101 is provided therein with signal lines 102 which run parallel to each other, and scanning lines 103 which run in a direction perpendicular to the signal lines 102, as shown in FIG. 11. Further, a TFT 104 (Thin Film Transistor) is provided near each of intersections of the signal lines 102 and the scanning lines 103.

When a gate driver 105 gets one of the scanning lines 103 to a selection state (High output), all of the TFTs 104 connected to the selected scanning line 103 come into an ON state. Pixel electrodes 110 connected to the ON-state TFTs 104 are charged with voltages outputted from a source driver 106 to the signal lines 102. Tones are expressed according to the applied voltages and thus an image is displayed.

Normally, a liquid crystal capacitor Clc 108 and an auxiliary capacitor Ccs 109 are charged with a voltage outputted from the source driver 106. A transmittance of a liquid crystal is determined according to a voltage across the pixel electrode 110 and a counter electrode.

However, in practice, a parasitic capacitor Cgd 107 exists between the scanning line 103 and the pixel electrode 110. Therefore, when a state of the scanning line 103 is changed from a selection state (High output) to a non-selection state (Low output), the voltage charged in the pixel electrode 110 while the scanning line 103 was in the selection state is drawn due to the influence of the parasitic capacitor Cgd 107. This drawn voltage ΔV is calculated as follows.

ΔV=(VGH−VGL)×Cgd+(Clc+Ccs+Cgd)

VGH: a voltage when the scanning line 103 is in the selection state

VGL: a voltage when the scanning line 103 is in the non-selection state

Cgd: a parasitic capacitor between the scanning line 103 and the pixel electrode 110

Clc: a liquid crystal capacitor

Ccs: an auxiliary capacitor

In consideration of ΔV, the source driver 106 is designed to output a voltage that is a sum of a voltage to be originally applied on the pixel electrode 110 and ΔV, so as to apply a proper voltage on the pixel electrode 110 after the voltage was drawn by ΔV due to the influence of the parasitic capacitor Cgd 107.

However, because a dielectric constant of a liquid crystal in a direction parallel to its molecular long axis differs from a dielectric constant of the liquid crystal in a direction perpendicular to the molecular long axis (dielectric anisotropy), capacitance of the liquid crystal capacitor (Clc 108) varies depending on an alignment of the liquid crystal, in other words, a voltage applied on the liquid crystal. That is to say, the drawn voltage (ΔV) depends on a tone, a center (a center of amplitude) between a positive electrical potential to be applied when driving with a positive polarity and a negative electrical potential to be applied when driving with a negative polarity (Ω characteristic) varies with respect to each tone. Therefore, for example, if an electrical potential of the counter electrode is set based on a white tone, a proper voltage is not applied on a liquid crystal when expressing a black tone, consequently, a DC voltage continues to be applied on the liquid crystal, which causes a screen burn-in.

In order to deal with Ω characteristic (in order to perform Ω correction), Patent Citation 1 discloses an arrangement in which a tone voltage generating circuit is provided for each tone so as to change the center of amplitude of a tone voltage corresponding to each tone. Further, Patent Citation 2 discloses an arrangement in which in consideration of Ω characteristic, a ladder resistance in a source driver has different divided ratios between a positive pole and a negative pole.

### [Patent Citation 1]

Japanese Unexamined Patent Publication No. 5-203918 (published date: Aug. 13, 1993)

### [Patent Citation 2]

Japanese Unexamined Patent Publication No. 2001-100711 (published date: Apr. 13, 2001)

### DISCLOSURE OF INVENTION

### Problems to be Solved by the Invention

However, in the arrangement disclosed in Patent Citation 1, tone voltage generating circuits are required in the number of tone, which costs too much in consideration of a recent mainstream of 6 bits and 64 tones, or 8 bits and 256 tones. In addition, Ω correction with respect to each liquid crystal panel cannot be easily performed.

In the arrangement disclosed in Patent Citation 2, the ladder resistance ratio in the source driver is set in consideration of Ω characteristic. However, when the dielectric constant of the liquid crystal or the capacitance of the auxiliary capacitor (Ccs 109) varies with respect to each liquid crystal panel, the optimal ladder resistance ratio also varies. That is, in order to perform Ω correction with respect to each liquid crystal panel, the arrangement of the source driver has to be changed (as hardware) with respect to each liquid crystal panel.

The present invention has been accomplished in view of the problems above, and an object of the present invention is to provide a liquid crystal panel driving device capable of easily performing Ω correction with respect to each liquid crystal panel.

The liquid crystal panel driving device according to the present invention is a liquid crystal panel driving device for AC-driving a liquid crystal display device with first and second polarities, including an output tone generating section for generating an output tone corresponding to an input tone, the output tone generating section generating, for the same input tone, a first output tone when driving with the first polarity, and generating a second output tone when driving with the second polarity. For example, with respect to an input tone Ti, the output tone generating section generates a first output tone T1 when driving with the first polarity, and generates a second output tone T2 that differs from the first output tone T1 when driving with the second polarity.

With the arrangement, even when Ω characteristic changes with respect to each liquid crystal panel, it is possible to deal with the change by changing the first and second output tones (digital data) accordingly. For example, the first and second output tones T1 and T2 are determined (changed) based on the characteristic of the input tone and the center of amplitude of a voltage to be outputted in response to the input tone in AC driving. As a result, Ω correction with respect to each liquid crystal panel can be easily performed.

It is preferable to arrange the liquid crystal panel driving device so as to include a look-up table for the first polarity and a look-up table for the second polarity, the output tone generating section generating the first output tone by using the look-up table for the first polarity, and the second output tone by using the look-up table for the second polarity. With the arrangement, Ω correction with respect to each liquid crystal panel can be easily performed by changing the look-up tables for the first and second polarities accordingly. In this case, the liquid crystal panel driving device may be arranged so that each of the look-up table for the first polarity and the look-up table for the second polarity includes look-up tables corresponding to input tones R, G, and B, respectively, and with respect to the input tones R, G, and B, the output tone generating section uses the corresponding look-up tables included in the look-up table for the first polarity or the look-up table for the second polarity. With the arrangement, the first and second output tones can be generated in consideration of a color temperature of an achromatic color. In addition, each look-up table can be stored in a storage section in the liquid crystal panel driving device.

It is preferable to arrange the liquid crystal panel driving device so that the output tone generating section generates the first output tone or the second output tone by performing a tone conversion (Ω correction) process and a gamma correction process in combination based on the characteristic. The Ω correction performed in combination with the gamma correction enables efficient data processing.

The liquid crystal panel driving device may be arranged so as to include a pseudo multi-tone processing section for performing a pseudo multi-tone process based on the first and second output tones.

The liquid crystal panel driving device may be arranged so that the first and second output tones are generated alternately when the same input tone continues in a time series (the input tone Ti is indicative of temporally continuous display).

The liquid crystal panel driving device may be arranged so that a timing controller serves as the output tone generating section. The timing controller is originally a device that processes data and generates a timing signal. Thus, by adding the function of the output tone generating section to the timing controller, it becomes possible to simplify the configuration and reduce the cost.

The method according to the present invention for driving a liquid crystal panel is a method for AC-driving a liquid crystal display with first and second polarities, including: generating first data D1 indicative of a tone T1 with respect to input data indicative of a tone Ti when driving with the first polarity, and generating second data D2 indicative of a tone T2 that differs from the tone T1 with respect to the input data indicative of the tone Ti when driving with the second polarity. In this case, the method may be arranged so that when the input data indicative of the tone Ti continues in a time series (the input data indicative of the tone Ti is indicative of temporally continuous display), the first and second data are generated alternately in the time series.

It is preferable to arrange the method so that the tone T1 and the tone T2 are determined based on the characteristic of the input tone and the center of amplitude of a voltage to be outputted in response to the input tone in AC driving (Ω characteristic).

The liquid crystal display according to the present invention includes the liquid crystal panel driving device and the liquid crystal panel.

As described above, by the liquid crystal panel driving device according to the present invention, even if Ω characteristic changes with respect to each liquid crystal panel, it is possible to deal with the change by changing the first and second output tones (digital data) accordingly. That is, Ω correction with respect to each liquid crystal panel can be performed easily.

### BRIEF DESCRIPTION OF DRAWINGS

FIG. 1 is a block diagram showing a main part of a liquid crystal panel driving device of the present invention.

FIG. 2 is a schematic showing mainly an inside of a panel of an active matrix liquid crystal display device.

FIG. 3 is a block diagram showing a main part of a liquid crystal panel driving device of the present invention.

FIG. 4 is a block diagram showing a main part of a liquid crystal panel driving device of the present invention.

FIG. 5 is a block diagram showing a main part of a liquid crystal panel driving device of the present invention.

FIG. 6 is a look-up table in accordance with an embodiment of the present invention.

FIG. 7 is a look-up table in accordance with an embodiment of the present invention.

FIG. 8 is a graph showing voltages outputted with respect to each tone by a source driver according to the present invention, and midpoint potentials thereof.

FIG. 9 is a conventional look-up table for a gamma correction.

FIG. 10 is a graph showing voltages outputted with respect to each tone by a conventional source driver, and midpoint potentials thereof.

FIG. 11 is a schematic showing a configuration of a common liquid crystal display panel.

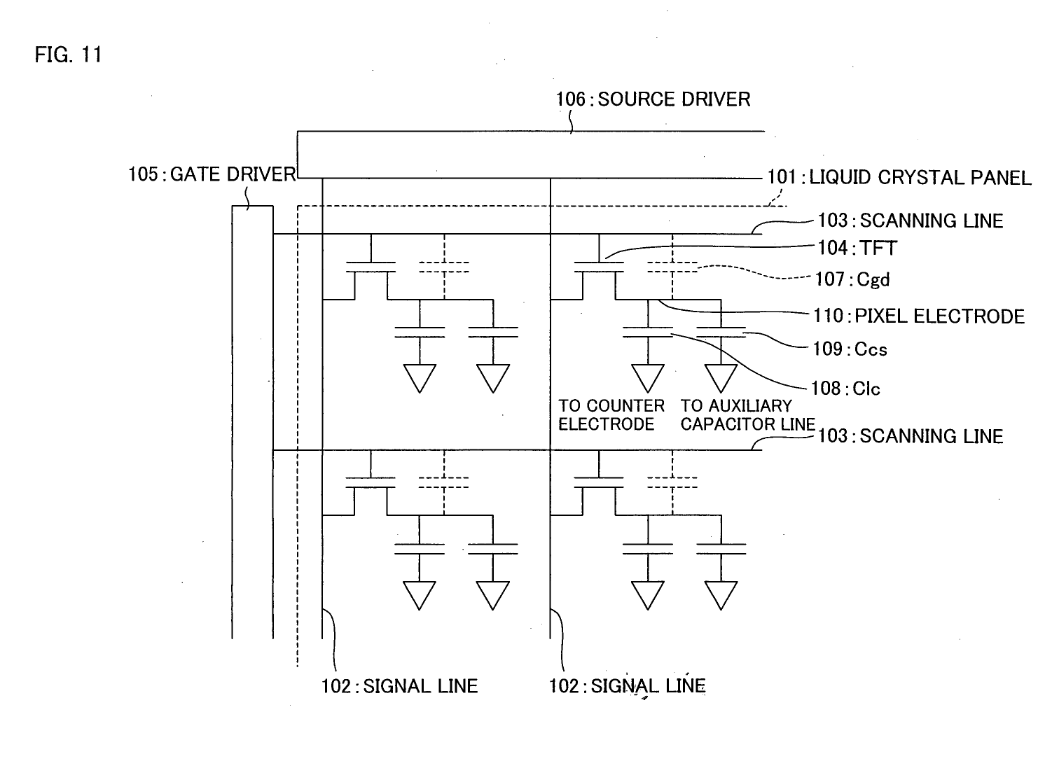

### DESCRIPTION OF REFERENCE NUMERALS

1: LIQUID CRYSTAL PANEL
4: LIQUID CRYSTAL PANEL DRIVING DEVICE
5: GATE DRIVER
6: SOURCE DRIVER
7: DRIVING POLARITY JUDGING SECTION
8: LUT FOR POSITIVE POLARITY
9: LUT FOR NEGATIVE POLARITY
10: Ω CORRECTION/GAMMA CORRECTION PROCESSING SECTION
11: LIQUID CRYSTAL DISPLAY DEVICE
12: VIDEO SIGNAL SOURCE
13: RGB DATA
14: CK
15: ENAB
16: HSYNC
17: VSYNC
18: TIMING CONTROLLER
19: EEPROM
20: I2C
21: RGB DATA
22: SCK
23: LS
24: REV
25: SSP
26: GCK
27: GSP

### BEST MODE FOR CARRYING OUT THE INVENTION

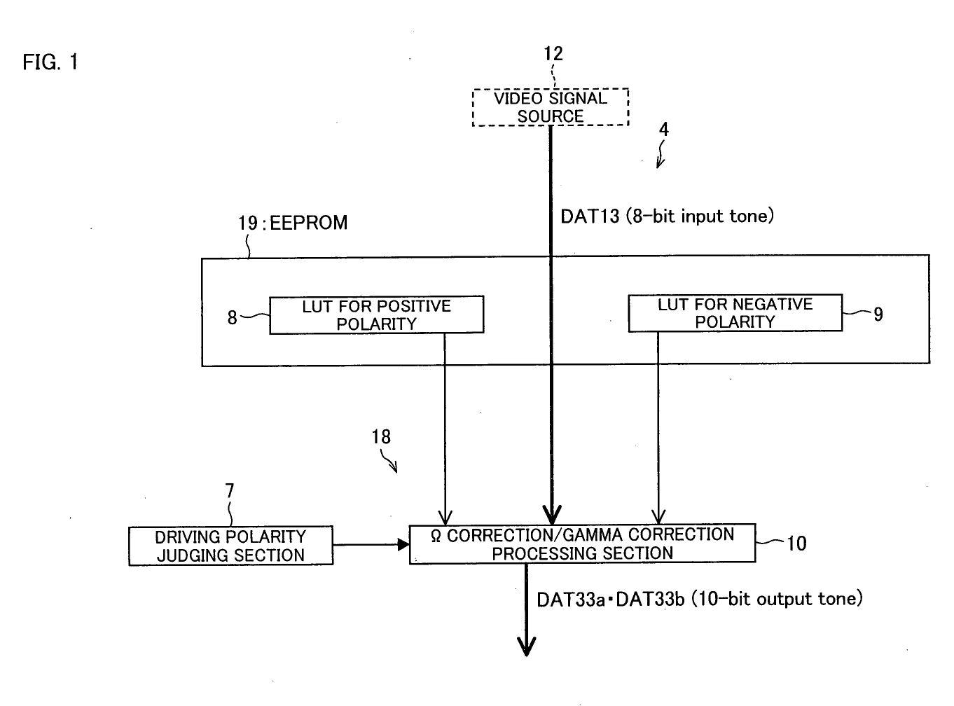

Embodiments of the present invention are described below with reference to FIGS. 1-10.

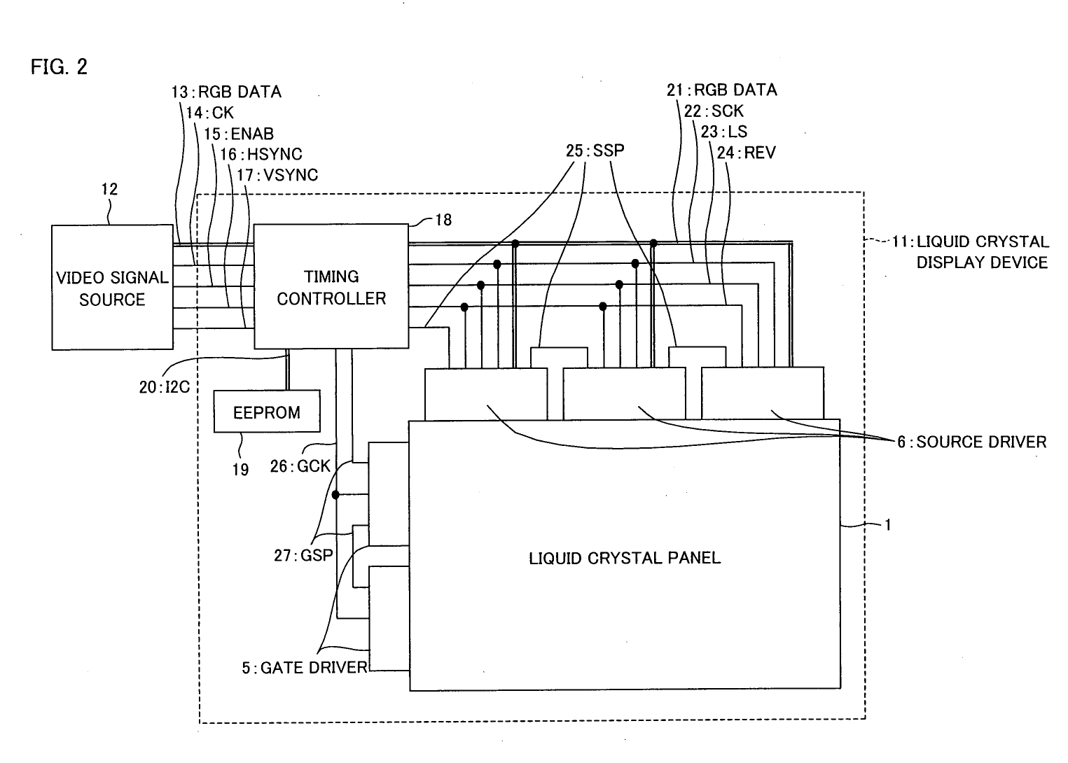

FIG. 2 is a block diagram showing an arrangement of a liquid crystal display device according to the present invention. FIG. 1 is a block diagram showing an arrangement of a main part of a driving device that the liquid crystal display device includes.

As shown in FIGS. 1 and 2, a liquid crystal display device 11 includes: a liquid crystal panel 1; a liquid crystal panel driving device 4 that includes a timing controller 18 and an EEPROM 19; a source driver 6; and a gate driver 5. The timing controller 18 includes a Ω correction/gamma correction processing section 10 and a driving polarity judging section 7.

The timing controller 18 receives the following signals from a signal source 12 provided outside the liquid crystal display device 11: RGB data 13 (8-bit input tone DAT13); a clock signal CK 14; ENAB 15 that indicates that data is in process of transfer; a horizontal synchronizing signal HSYNC 16; and a vertical synchronizing signal VSYNC 17. LVDS (Low Voltage Differential Signaling) may be employed to transmit the signals from the signal source 12 to the timing controller 18. However, a difference in the method for transmitting the signals does not affect contents of the data, and the method itself is not the essence of the present invention. Thus, it is assumed that the signals are transmitted in a CMOS (Complementary Metal Oxide Semiconductor) level.

The timing controller 18 reads a look-up table from the EEPROM 19 (Electronically Erasable and Programmable Read Only Memory) by using a communication protocol such as I2C 20 (Inter Integrated Circuit). Based on the read look-up table and the received RGB data 13, Ω correction and gamma correction of RGB data are performed inside the timing controller 18.

Specifically, as shown in FIG. 1, the Ω correction/gamma correction processing section 10 (an output tone generating section) generates DAT 33a/DAT 33b (10-bit output tone) based on the DAT 13 (8-bit input tone) transmitted from the video signal source 12, and on a LUT 8 for positive polarity or a LUT 9 for negative polarity that is read according to a judgment of the driving polarity judging section 7.

For example, assume that the DAT 13 is indicative of a tone Ti (any color of R, G, and B). In case where the judgment by the driving polarity judging section 7 shows a driving with a positive polarity, the Ω correction/gamma correction processing section 10 reads the LUT 8 for positive polarity and generates the DAT 33a indicative of a tone T1. In case where the judgment by the driving polarity judging section 7 shows a driving with a negative polarity, the Ω correction/gamma correction processing section 10 reads the LUT 9 for negative polarity and generates the DAT 33b indicative of a tone T2 (which differs from the tone T1). In addition, in case where the DAT 13 continues to be indicative of the tone Ti (e.g. in case where DAT 13 is indicative of a still image), the DAT 33a and the DAT 33b are generated alternately.

The LUT 8 for positive polarity and the LUT 9 for negative polarity are generated based on a characteristic of an input tone and a center of amplitude of a voltage to be outputted according to the input tone in AC driving (Ω characteristic), and gamma characteristic. Therefore, the DAT 33a (D1) and the DAT 33b (D2) are data obtained by processing the DAT 13 with Ω correction and gamma correction.

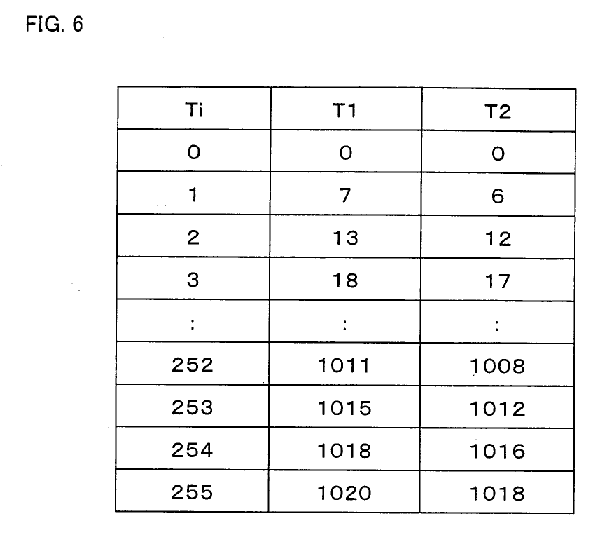

FIG. 6 shows an example of the LUT 8 for positive polarity showing a combination of Ti and T1, and an example of the LUT 9 for negative polarity showing a combination of Ti and T2. Ti is an expression of 8 bits and 256 tones, and Ti and T2 are expressions of 10 bits and 1024 tones. 256 Tis correspond to 256 T1s or 256 T2s, respectively, that are selected from 1024 T1s or 1024 T2s.

The timing controller 18 outputs the DAT 33a and the DAT 33b, or the DAT 33a and the DAT 33b subjected to a desired process (a pseudo multi-tone process or a tone transition emphasis process), to the source driver 6 as RGB data 21 (8-bit or 10-bit digital data DAT 21).

The source driver 6 generates a signal potential (analog data) by using the RGB data 21, SCK 22 (a clock of the source driver), LS23 that determines a timing for outputting data to the liquid crystal panel 1, REV 24 that determines a polarity when writing in the liquid crystal panel 1, and SSP 25 that determines a timing for receiving the RGB data 21. The source driver 6 outputs this signal potential to a signal line 2 of the liquid crystal panel 1. For example, when the RGB data 21 is based on the DAT 33a, a signal potential that is positive (+) with respect to a potential of the counter electrode is generated. When the RGB data 21 is based on the DAT 33b, a signal potential that is negative (−) with respect to a potential of the counter electrode is generated. As a result, the liquid crystal panel 1 is AC-driven.

As described above, even if Ω characteristic changes with respect to each liquid crystal panel, the liquid crystal panel driving device 4 (see FIG. 1) of the present invention can deal with the change by changing the LUT 8 for positive polarity and LUT 9 for negative polarity accordingly. That is, the liquid crystal panel driving device 4 is highly applicable to each type of the liquid crystal panels.

In the present embodiment, the DAT 33a and the DAT 33b are expanded to 10 bits in order that the RGB data 21 has 256 tones. However, the DAT 33a and the DAT 33b can be 8 bits if 256 tones are not needed for the RGB data 21.

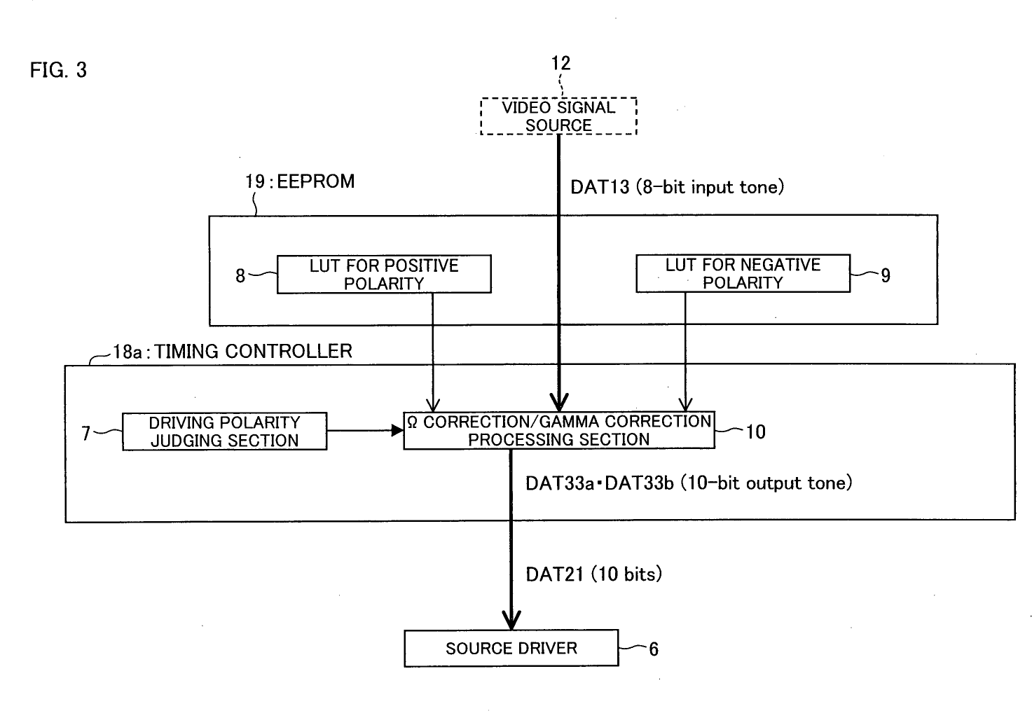

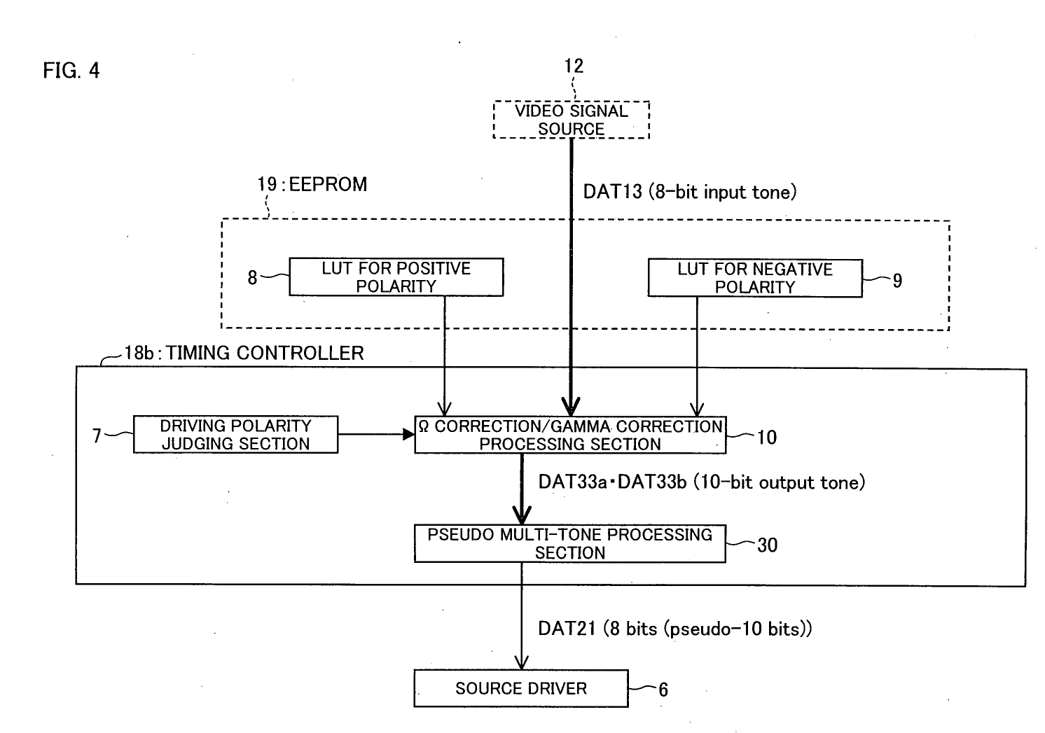

In addition, in case where the source driver 6 is designed to deal with 10-bit data, the DAT 33a and the DAT 33b (output tone) can be outputted directly to the source driver 6, as seen in a timing controller 18a shown in FIG. 3. Further, even in case where the source driver 6 is designed to deal with 8-bit data, pseudo-expression of 10 bits becomes possible by providing a pseudo multi-tone processing section 30 that performs a frame rate control (FRC) or dithering at a subsequent stage of the Ω correction/gamma correction processing section 10, as seen in a timing controller 18b shown in FIG. 4.

In the present embodiment, Ω correction and gamma correction are performed simultaneously in Ω correction/gamma correction processing section 10 for efficient data processing. However, these corrections may be separated as a former stage and a latter stage.

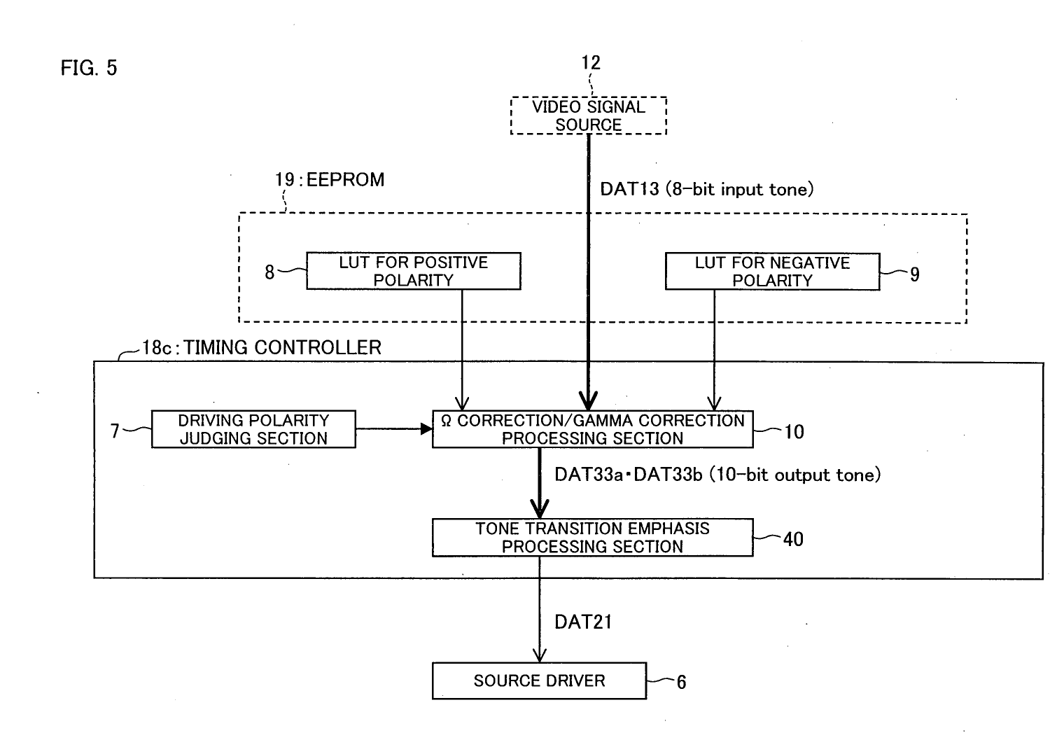

In addition, a tone transition emphasis processing (OS processing) section 40 may be provided at a subsequent stage of the Ω correction/gamma correction processing section 10, as seen in a timing controller 18c shown in FIG. 5.

RSDS (Reduced Swing Differential Signaling) may be employed to transmit the signals from the timing controller 18 to the source driver 6. However, a difference in the method for transmitting the signals does not affect contents of the data, and the method itself is not the essence of the present invention. Thus, it is assumed that the signals are transmitted in a CMOS level.

To the gate driver 5, GCK 26 that is a clock of the gate driver 5, and GSP 27 that determines beginning of a frame are outputted. According to these data, the gate driver 5 outputs a voltage that is in a selection state or a non-selection state to a scanning line 3 in the liquid crystal panel 1.

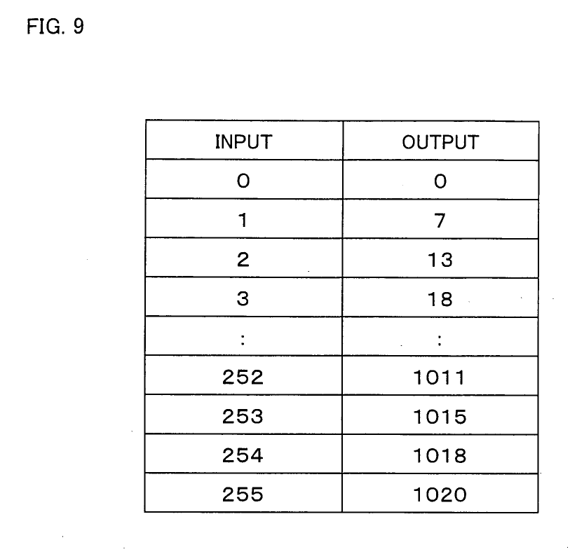

FIG. 9 shows a conventional look-up table for gamma correction. In the look-up table shown in FIG. 9, it is possible to adjust arbitrarily a ratio of display brightness corresponding to input tone data, but not to reflect Ω characteristic. In contrast, in the present embodiment, two look-up tables are provided depending on a driving polarity, as shown in FIG. 6. By using the LUT 8 for positive polarity when driving with the positive polarity, and the LUT 9 for negative polarity when driving with the negative polarity, it is possible to reflect Ω characteristic of each type of the liquid crystal panels.

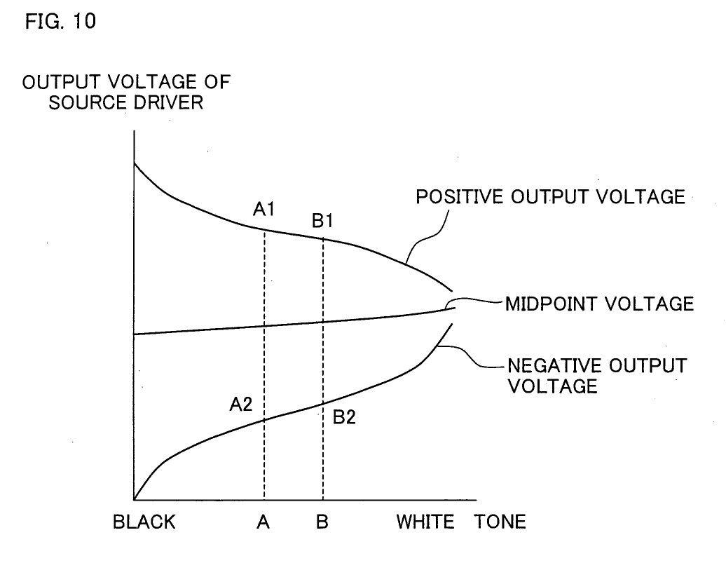

FIG. 10 shows a voltage outputted to the source driver when conventional gamma correction is performed. For example, when an input tone is A (a voltage A1 on the positive side, A2 on the negative side, is outputted without gamma correction), the tone A is converted into a tone B by gamma correction, and therefore a voltage B1 on the positive side, B2 on the negative side, is outputted. That is, by determining the tone (B) converted from the input tone (A) by gamma correction according to the look-up table, amplitude (B1-B2) of the voltage outputted by the source driver in response to the input tone can be determined arbitrarily. This means that the ratio of display brightness to the input tone can be determined arbitrarily by using the look-up table. However, in this conventional arrangement, although the amplitude of the voltage outputted by the source driver can be determined arbitrarily, a midpoint potential thereof (a center) cannot be determined arbitrarily. It is requested that a value obtained by subtracting ΔV from the midpoint potential is equal to a potential of the counter electrode. However, ΔV changes when a dielectric constant of a liquid crystal or a capacitance of an auxiliary capacitor (Ccs 109) varies among liquid crystal panels. As a result, an optimal midpoint potential also changes. That is, in the conventional arrangement where the midpoint potential of the tone B is determined according to hardware, it is difficult to change Ω characteristic accordingly (perform Ω correction according to each liquid crystal panel).

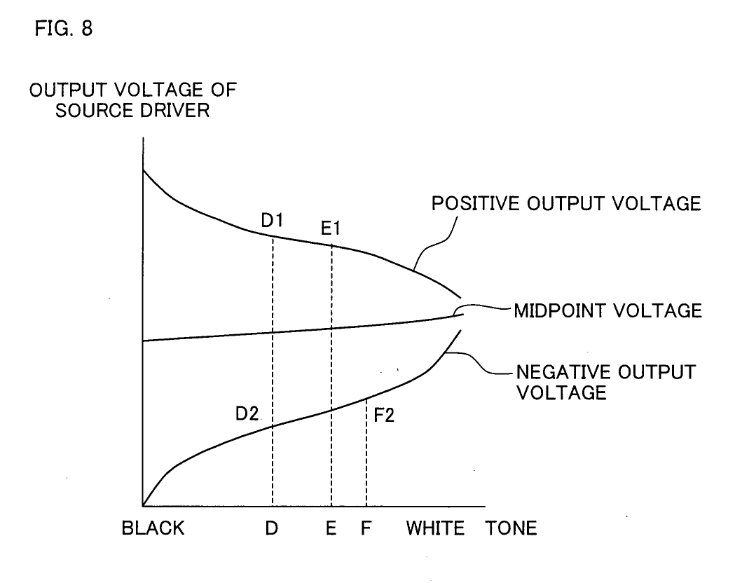

In contrast, in the present embodiment, two look-up tables are provided depending on a driving polarity (a polarity when applying a voltage on the liquid crystal). As shown in FIG. 8, when a tone D is inputted, the tone D is converted into a tone E when driving with the positive polarity, and into a tone F when driving with the negative polarity. This enables arbitrary setting not only the amplitude (E1-F2) of the voltage outputted in response to the input tone, but also the midpoint potential (Ω characteristic). That is, even when the dielectric constant of the liquid crystal or the capacitance of the auxiliary capacitor varies with respect to each liquid crystal panel, Ω correction can be performed easily by changing a parameter of the look-up table (LUT 8 for positive polarity, LUT 9 for negative polarity) without changing the arrangement inside the source driver. Consequently, the liquid crystal display device 11 with few display defects (such as a screen burn-in caused by continuously applying a DC voltage) can be established.

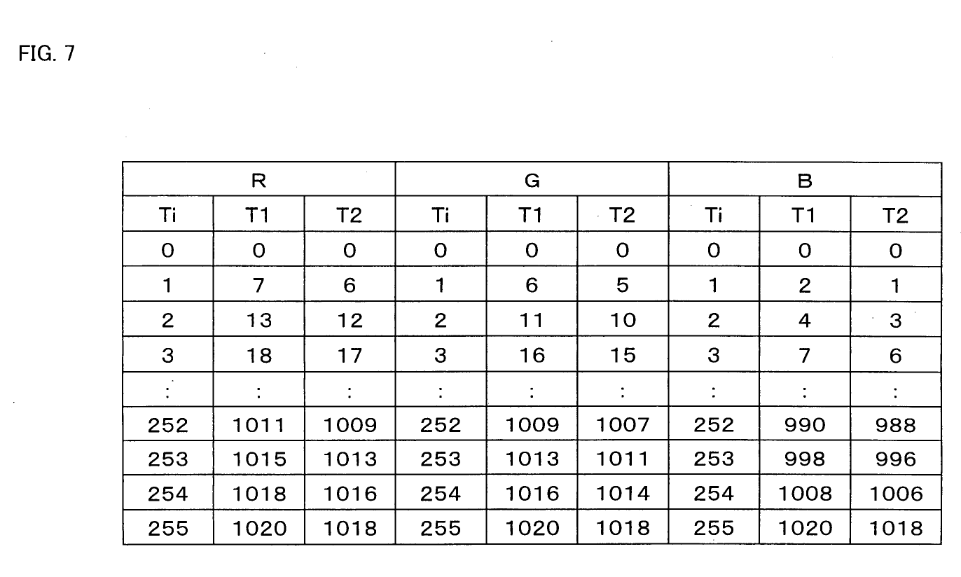

In the present embodiment, different look-up tables can be used for R, G, and B, respectively. By using the different look-up tables for R, G, and B respectively as shown in FIG. 7, a color liquid crystal display having excellent color reproducibility can be established (in this regard, see Japanese Unexamined Patent Publication No. 2001-42833).

In the embodiment described above, an explanation was made as to a case where, in a normally-white active matrix liquid crystal display device that transmits light when applying no voltage on a liquid crystal, gamma correction of the input data is performed by using the look-up table inside the timing controller. However, the present invention is not limited to this case.

### INDUSTRIAL APPLICABILITY

The present invention is suitably applicable to a liquid crystal display device used in a TV, a monitor, a mobile terminal, and an onboard display, for example.

1. A liquid crystal panel driving device for AC-driving a liquid crystal panel with first and second polarities, the liquid crystal panel driving device comprising:
an output tone generating section for generating an output tone corresponding to an input tone,
the output tone generating section generating, for a same input tone, a first output tone when driving with a first polarity, and a second output tone when driving with a second polarity.

2. The liquid crystal panel driving device according to claim 1, wherein:
the first and second output tones are determined based on a characteristic of an input tone and a center of amplitude of a voltage to be outputted in response to the input tone in AC driving.

3. The liquid crystal panel driving device according to claim 1, which, for an input tone Ti, generates a first output tone T1 when driving with the first polarity, and generates a second output tone T2 that differs from the first output tone T1 when driving with the second polarity.

4. The liquid crystal panel driving device according to claim 3, further comprising a look-up table for the first polarity and a look-up table for the second polarity,
the output tone generating section generating the first output tone by using the look-up table for the first polarity, and generating the second output tone by using the look-up table for the second polarity.

5. The liquid crystal panel driving device according to claim 4, wherein
each of the look-up table for the first polarity and the look-up table for the second polarity includes look-up tables corresponding to input tones R, G, and B, respectively, and
with respect to the input tones R, G, and B, the output tone generating section uses the corresponding look-up tables included in the look-up table for the first polarity or the look-up table for the second polarity.

6. The liquid crystal panel driving device according to claim 2, wherein:
the output tone generating section generates the first output tone or the second output tone by performing a tone conversion process and a gamma correction process in combination based on the characteristic.

7. The liquid crystal display driving device according to claim 1, further comprising a pseudo multi-tone processing section for performing a pseudo multi-tone process based on the first and second output tones.

8. The liquid crystal panel driving device according to claim 3, wherein:
the first output tone T1 and the second output tone T2 are generated alternately when the input tone Ti is indicative of temporally continuous display.

9. A method for AC-driving a liquid crystal panel with first and second polarities, the method comprising:
generating first data D1 indicative of a tone T1 with respect to input data indicative of a tone Ti when driving with the first polarity; and
generating second data D2 indicative of a tone T2 that differs from the tone T1 with respect to the input data indicative of the tone Ti when driving with the second polarity.

10. The method according to claim 9, wherein:
the first data D1 and the second data D2 are generated alternately when the input data indicative of the tone Ti is indicative of temporally continuous display.

11. The method according to claim 9, wherein:
the tone T1 and the tone T2 are determined based on a characteristic of an input tone and a center of amplitude of a voltage to be outputted in response to the input tone in AC driving.

12. A liquid crystal display device, comprising:
a liquid crystal panel; and
a liquid crystal panel driving device according to claim 1.

13. A liquid crystal display device, comprising:
a liquid crystal panel; and
a liquid crystal panel driving device according to claim 2.

14. A liquid crystal display device, comprising:
a liquid crystal panel; and
a liquid crystal panel driving device according to claim 3.

15. A liquid crystal display device, comprising:
a liquid crystal panel; and
a liquid crystal panel driving device according to claim 4.

16. A liquid crystal display device, comprising:
a liquid crystal panel; and
a liquid crystal panel driving device according to claim 5.

17. A liquid crystal display device, comprising:
a liquid crystal panel; and
a liquid crystal panel driving device according to claim 6.

18. A liquid crystal display device, comprising:
a liquid crystal panel; and
a liquid crystal panel driving device according to claim 7.

19. A liquid crystal display device, comprising:
a liquid crystal panel; and
a liquid crystal panel driving device according to claim 8.
